(19) United States
(12) Patent Application Publication
(10) Pub. No.: US 2003/0026448 A1
(43) Pub. Date: Feb. 6, 2003

(54) Data encoding and decoding using angular symbology

(76) Inventors: Eric Metois, Arlington, MA (US); Joshua R. Smith, Cambridge, MA (US)

Correspondence Address: CESARI AND MCKENNA, LLP, 88 BLACK FALCON AVENUE, BOSTON, MA, 02210, US

(21) Appl. No.: 09/921,172

(22) Filed: Aug. 2, 2001

(51) Int. Cl. G06K 9/00

(52) U.S. Cl. 382/100

(57) ABSTRACT

A system for encoding data into and decoding data from a coded pattern using angular symbology in which symbols are represented by angular orientations of data modulation patterns relative to a reference modulation pattern. The modulation patterns are selected to have components that are localized in a Fourier transform domain. An example of a modulation pattern is a sinusoidal linear pattern in which spatial frequency and angular orientation are localized in the magnitude Fourier transform domain. In one embodiment of the present invention, one or more symbols may be encoded in one or more portions of an image by varying a characteristic of one or more elements of the image in accordance with the data and reference modulation patterns. An element may be image pixels, and the coded pattern is represented by variations to the intensities of the pixels. The coded pattern may be reproduced as a grayscale texture or combined with a non-coded image by adding a graininess to the image. To decode the coded pattern the system performs a two-dimensional fast Fourier transform and identifies the spatial frequencies and relative angular orientations associated with the respective modulation patterns. The system then associates the angular orientations with symbols and arranges the symbols in accordance with the associated spatial frequency values to reproduce the data.

### BACKGROUND OF THE INVENTION

1. Field of the Invention

The invention relates generally to data encoding and decoding and, more particularly, to encoding data onto, and decoding data from, an underlying substrate, such as a non-coded image.

2. Background Information

There are numerous applications in which machine readable data must be encoded on a paper document or other substrate. Typically such data is encoded using a printable symbology, either as a form of barcode, or as characters optimized for Optical Character Recognition, i.e., in an “OCR type font.” There are numerous applications of machine readable printed symbologies, for example: product identification—notably the ubiquitous Universal Product Code symbol, document identification, postal mailpiece identification and sorting, and so on. Even postage itself may be represented by a machine readable printed symbology, as for example in the United States Postal Service's Information Based Indicia Program.

A barcode specifies data symbols as an arrangement of lines that vary in relative size and spacing. In one dimensional (1-D) barcodes the lines vary by width and relative horizontal spacing. In two dimensional (2-D) barcodes, the lines vary also by relative vertical length or relative position. As is common, the barcodes may be overlaid on an otherwise blank portion of, for example, a price tag.

The three main advantages of barcodes are that they are printable using a simple “black and white” printing process, are machine readable using a scanner, and are easily decoded. However, current barcodes suffer from a number of limitations, Specifically, 1D barcodes do not encode enough data per square inch of paper for many applications. Two dimensional barcodes encode more data, but are visually obtrusive. Typically, a barcode must have its own reserved area including a white or uniform background for the barcode itself, as well as a white or uniform border (known as a “quiet zone”) that is actually larger than the barcode itself. We refer to the reserved area and the quiet zone together as the “barcode region.” Other visual content must be eliminated from the barcode region, which in most practical applications limits the realizable data carrying capacity since the space, or “real estate,” that may be devoted solely to the machine readable symbol is limited.

Barcodes may also be too visually intrusive to be combined with certain media, such as, for example, photographic images. A combination of the barcode region and the underlying image essentially obliterates the portions of the image in which the barcode is included. Accordingly, the use of the barcode may not be acceptable. Further, the relative spacings, widths and other characteristics of the barcode may be altered if the combined image is scaled or compressed for transmission, or if the combined image is tilted or rotated as it is scanned for transmission. In addition, the barcode may be defaced before, during or after transmission. The encoded data in the received image cannot then be accurately decoded by the recipient.

Further, another of the reasons that barcodes and other prior printed symbologies cannot be successfully combined with images is that they typically encode the data in a spatially localized form, which means that if any portion of the symbol is destroyed, not viewable by the scanner, or obfuscated by an image, a portion or all of the data may be lost. The localized representation of the data thus limits the robustness of the encoding.

A final limitation of most symbologies known in the art is their stringent registration requirements. The coded pattern must be correctly oriented, positioned and sized relative to a viewing window of the scanner in order to be properly read and decoded. If only a portion of the barcode passes by the viewing window or the code is incorrectly registered, the scanner may misinterpret the data included in the coded pattern, without notifying the user of the mistake. It is necessary for the reading device effectively to view and identify the edges (left and right for a 1D barcode, left, right, top, and bottom for a 2D barcode) of the bar code region before any of the data can be recovered. If the edges of the barcode region are obfuscated, out of view, or destroyed, the scanner may not be able to decode any of the data, even though only a small edge portion of the coded pattern and/or the surrounding quiet zone has been destroyed or is not viewable by the scanner. In addition, with the stringent registration requirements, barcodes and other prior printed symbologies are not particularly well suited for use in fully automated reading system. In systems such as a market checkout, for example a user is present to properly position and orient the coded pattern, for example, the barcode, relative to the viewing window. Thus, it is commonplace for a user to move an object further from or closer to the window, and/or reorient the product relative to the window until the check-out scanner correctly decodes the price, product type and so forth. In a fully automated system, however, registration of the barcodes relative to the scanner window may be a problem if the underlying media tilts, rotates or shifts relative to the scanned window. Accordingly, the barcodes may not be successfully read.

What is needed is a symbology that is robust to destruction or obfuscation throughout, and yet visually satisfying in a combined image or as a stand-alone pattern. The symbol must be printable in a simple “black and white” printing process, as well as more expensive and time-consuming process color or grayscale printing processes. Further, what is needed is a symbology that overcomes problems with registration, particularly in environments in which rotation, translation, compression and/or scaling and even defacement of the combined image or coded pattern may occur.

### SUMMARY OF THE INVENTION

The invention is an encoding system that includes data in an underlying image as a coded pattern using an “angular symbology” that is independent of translation and rotation. The coded pattern, which resembles a texture, may be used alone in a manner similar to a barcode. Alternatively, the pattern may be combined with an underlying image to include the data therein as an added texture or graininess.

The system encodes the data by varying an image characteristic in accordance with modulation patterns that have relative angular orientations and frequencies which correspond to the data. The modulation patterns may be, for example, sinusoidal linear patterns, and the image characteristic that is varied in accordance with the sinusoidal patterns may be, for example, pixel intensity.

Briefly, an elementary component is a modulation pattern that may be imposed on an underlying substrate at a defined orientation relative to a reference and which has a 2-D Fourier transform that is characterized by components that are sufficiently localized. These localized components can then be recovered without excessive computation. While in the preferred embodiment discussed herein the elementary component is a sinusoidal linear pattern that has a pair of impulse functions as its Fourier transform, the elementary component may be any other pattern that has a Fourier transform with sufficiently localized components.

To encode the data, which consists of a string of symbols, the system first specifies a reference elemental component by selecting a reference orientation and a reference frequency. The reference frequency is preferably selected to be the highest spatial frequency in a group or band of frequencies used to produce the coded pattern. The system next associates one or more symbols with each of the remaining spatial frequencies in the band by, for example, assigning a first set of symbols to the highest of the remaining set of frequencies, a second set of symbols to the next highest of the frequencies, and so forth. The system then assigns angular orientations to the respective symbols based on the numerical values of the symbols, where the “values” correspond to the underlying bits that are to be encoded in the components. Finally, the system determines how pixel intensities are to be varied by a combination of the reference and data elemental components, in order to impress a corresponding coded pattern on the substrate. Typically, this is done by printing the pattern on the substrate.

The result is a coded pattern that is essentially a texture or what is sometimes referred to herein as a “coded texture.” As discussed, the coded pattern may be used alone, and thus, printed as a texture or it may be combined with one or more non-coded images by adding a graininess to the underlying images.

The system recovers the data essentially by performing a 2-D fast Fourier transform (FFT) of the coded pattern, to recover the spatial frequencies and orientations. The resultant transform defines a set of “reference points” and various sets of “data points,” each of which are characterized by a frequency and an angular orientation corresponding to that of the visual modulation patterns that were impressed on the document. The system determines the reference orientation by determining the points of maximum energy at the reference spatial frequency. These points, which are the reference points, define a reference axis from which the angular orientations of the respective sets of data points are determined. The system then decodes the angular information into the corresponding symbols, and arranges the symbols to reproduce the data.

The angular symbology produces a coded pattern that is both translation and rotation independent, since rotation and translation do not change the spatial frequency or the relative angular orientation information obtained using the FFT. In addition, defacing the coded pattern will usually not preclude decoding, since the FFT produces functions that are supported by every pixel in the coded pattern. Thus, altering certain of the pixels by, for example, overwriting them, should not alter the results of the FFT in such a way that the system can no longer associate the results with the spatial frequencies and angular orientations used during encoding. Further, the decoding system can compensate for scaling changes by trying different scale values, which in the frequency domain is done by linearly scaling the spatial frequency values and testing them through decoding. Once valid data is retrieved, the testing is complete. The testing is thus not computationally intensive, and can be both automatically and quickly performed.

The data contained in the coded pattern can be recovered without having to detect, estimate and/or compensate for any translation, rotation or other misregistration of the coded pattern. Accordingly, the data can be readily decoded from a copy of the coded pattern, after the pattern has been sent by facsimile or otherwise transmitted and printed. Further, the coded pattern can be automatically read and decoded by machine, without user intervention, because misregistration of the coded pattern relative to a scanning window does not adversely affect the decoding operations.

### BRIEF DESCRIPTION OF THE DRAWINGS

The invention description below refers to the accompanying drawings, of which:

FIG. 1 is a simplified coded texture;

FIG. 2 depicts pictorially the results of a 2-D FFT of a coded texture;

FIG. 3 is a functional block diagram of an encoding system that produces the coded textures;

FIG. 4 is a functional block diagram of a decoding system; and

FIGS. 5A-B depict a non-coded image and a coded image, respectively.

### DETAILED DESCRIPTION OF AN ILLUSTRATIVE EMBODIMENT

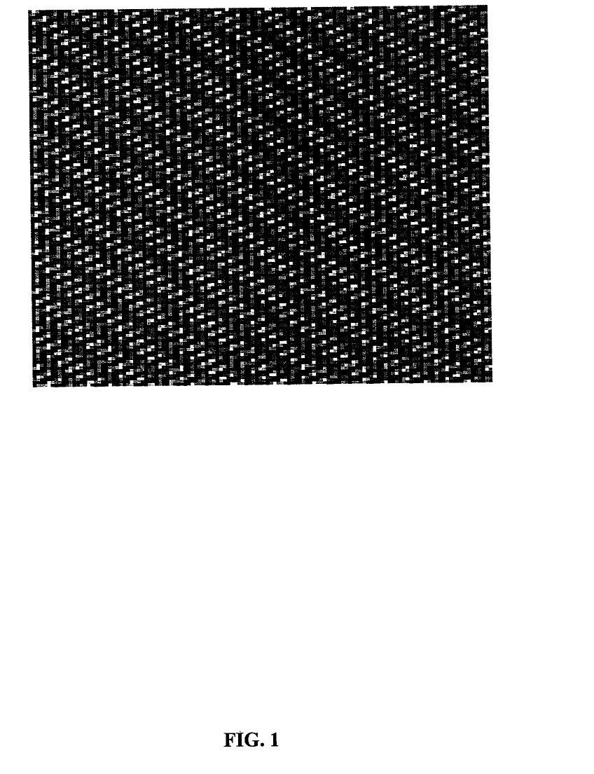

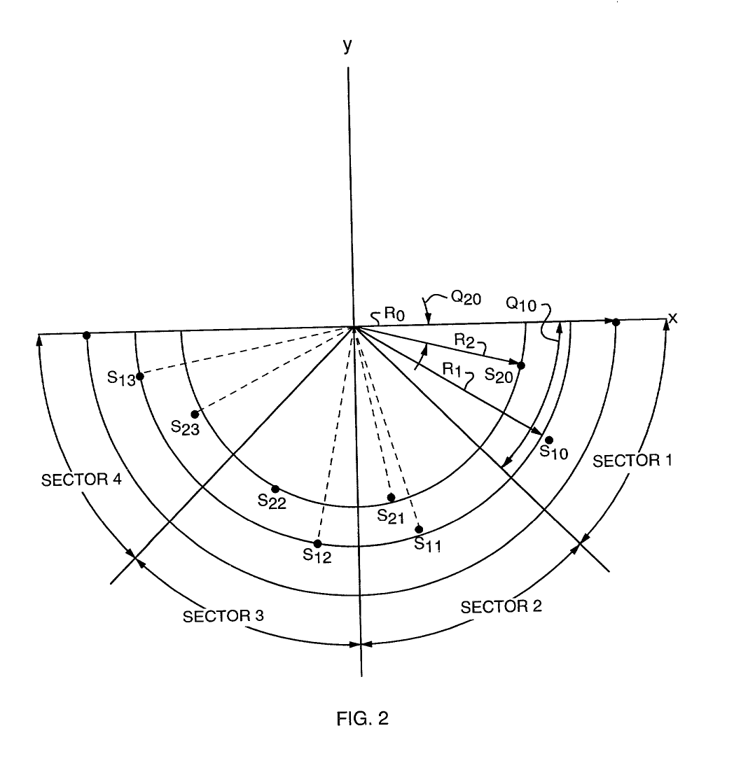

Referring now to FIGS. 1 and 2, an illustrative coded pattern 10 includes contributions from a set of elementary components, comprising a reference component and one or more data components. The contributions correspond to variations in pixel intensities that form a visual texture. For simplicity, we have included two data components in the coded pattern. It will be understood that typically more data components are included.

An elementary component is associated with a spatial frequency and an angular orientation. In the example, the elementary component is a sinusoidal linear pattern. The sinusoidal linear pattern is selected because this pattern is represented in the magnitude Fourier domain as a symmetrically positioned pair of non-zero points v_{i,0}, v_{i,1} that occur on a circle of radius Rᵢ, where Rᵢ corresponds to the associated spatial frequency. Further, the points are at an angle θ from a reference direction that corresponds to the angle of the spatial component with respect to a reference component.

By selecting a particular spatial frequency R₀ and angular orientation θ₀ as a reference, the system can define x and y axes on a Fourier plane based on the positions of the associated points v_{0,0} and v_{0,1} on the circle of radius R₀. Specifically, the system positions the x axis through the points and the y axis half-way between the points, such that the origin is at the center of the circle of radius R₀. The sets of data points that correspond to the remaining elementary components then have distances from the origin that correspond to the spatial frequencies and angular orientations of the coded pattern which defines the underlying data. Since each pair of data points is symmetric about the origin, only one of each pair is actually needed for the decoding. As a matter of choice, we used the data set comprising data points in the lower-half plane, and measure angles clockwise from the x reference axis.

FIG. 2 is a representative illustration of the magnitude Fourier domain transform of a set of sinusoidal spatial patterns, each designed by a pattern repetition frequency and a spatial pattern orientation relative to a referenced pattern. The radii Rᵢ, or the associated spacial frequencies, may be considered as information “carriers,” and will be referred to as such hereinafter. The magnitude of a given carrier (i.e., radial distance from the origin) corresponds to the spatial frequency of its associated elementary components. One of these carriers, referred to as the “reference carrier,” supports a single elementary component that conveys a reference orientation for the symbology. The remaining carriers, referred to as the “data carriers,” may each support a plurality of elementary components and are used to convey the data payload.

In accordance with the present invention, the data payload, which is a string of data or bits including both user data and error detection and correction information, is grouped into sets of symbols, Sᵢ, with each symbol comprising b bits. Each data carrier is assigned one or more symbols in the sequence, with each symbol being assigned a different angular orientation. Each one of the symbols will thus be conveyed by a different elementary component. In the preferred embodiment herein, we assign four symbols to each data carrier, with each symbol carrying four bits, and use seven data carriers so that a total payload of 112 bits can be carried by the coded texture.

This is illustrated in FIG. 2 which shows a reference carrier that defines the reference x axis, and data carriers R₁ and R₂, respectively. Each symbol S_{i,j} corresponding to a data carrier Rᵢ is assigned to a separate one of the four sectors, each sector occupying π/4 radians. This facilitates decoding since the angular orientation associated with a given symbol is measured in each sector. In the drawing carrier 1 is associated with symbols S_{1,0}, S_{1,1}, S_{1,2} and S_{1,3,} each located on or near the carrier radius R₁ but in a different one of the sectors, and similarly for carrier 2, etc.

The data capacity of the angular symbology depends on the accuracy with which angular orientation can be measured. Transmitting, copying or printing of the coded pattern as well as interference between the pattern and features of an underlying image may adversely affect the measurements. Accordingly, a system designer must determine the number of carrier frequencies based on the resolution with which the frequencies can be detected, and the number of image symbols per carrier and also the number of bits per symbol that can be reliably decoded from the coded pattern based on the resolution with which angular measurements can be made at the various frequencies. Higher frequency carriers are generally easier to detect and accurately measure. Thus, they may be used to convey more data symbols and/or larger data symbols then lower frequency carriers.

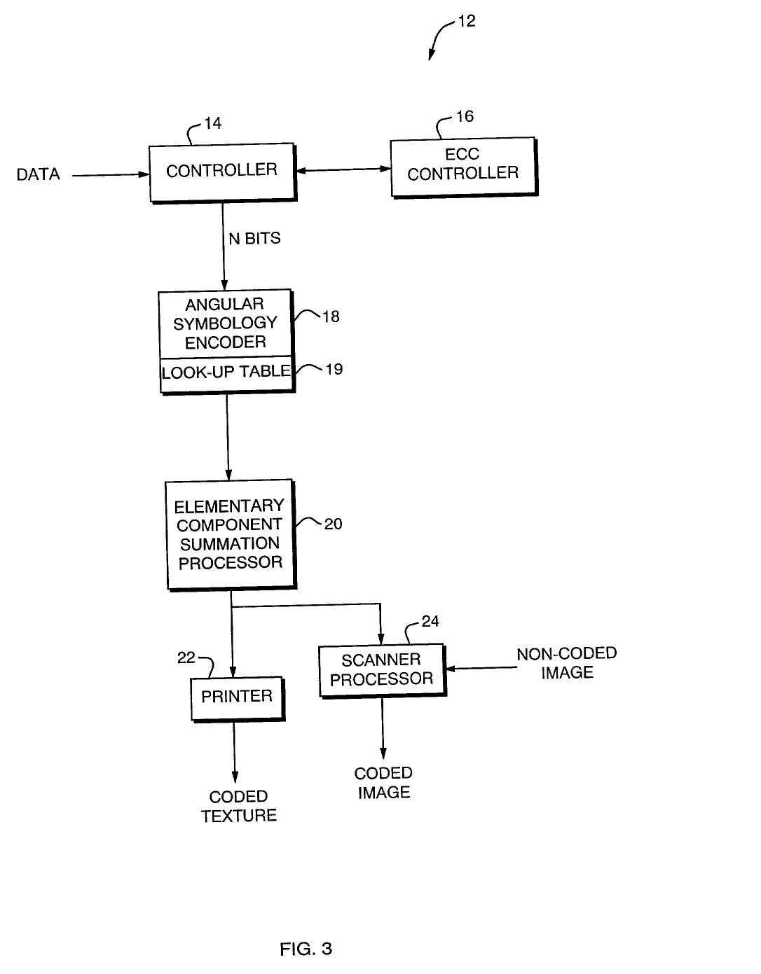

Referring now to FIG. 3, an encoding system 12 includes a controller 14 that receives data which is to be encoded to provide a coded pattern. The controller 14 controls an error correction encoder 16 that, in a conventional manner, encodes the data as a string of data symbols and produces corresponding error correction code detection and correction information such as parity bits or redundancy symbols, which are referred to collectively herein as “ECC symbols.” The controller 14 then concatenates the data and the ECC symbols into a payload of N bits.

An angular symbology encoder 18 parses the N bits into image symbols of, for example, 4 bits each. The encoder then associates the image symbols with selected spatial frequencies, or data carriers, based on the positions of the symbols in the N-bit payload. The system assigns the first d symbols to a first data carrier, the second d symbols to a second data carrier and so forth. Next, the system assigns an angular orientation to a given symbol based on the symbol numerical value. The encoding system of FIG. 1 uses a lookup table 19 to assign an angular orientation to an image symbol, entering the table with the symbol. Alternatively, the angular symbology encoder 18 may calculate the angular orientation for the image symbol, as discussed below.

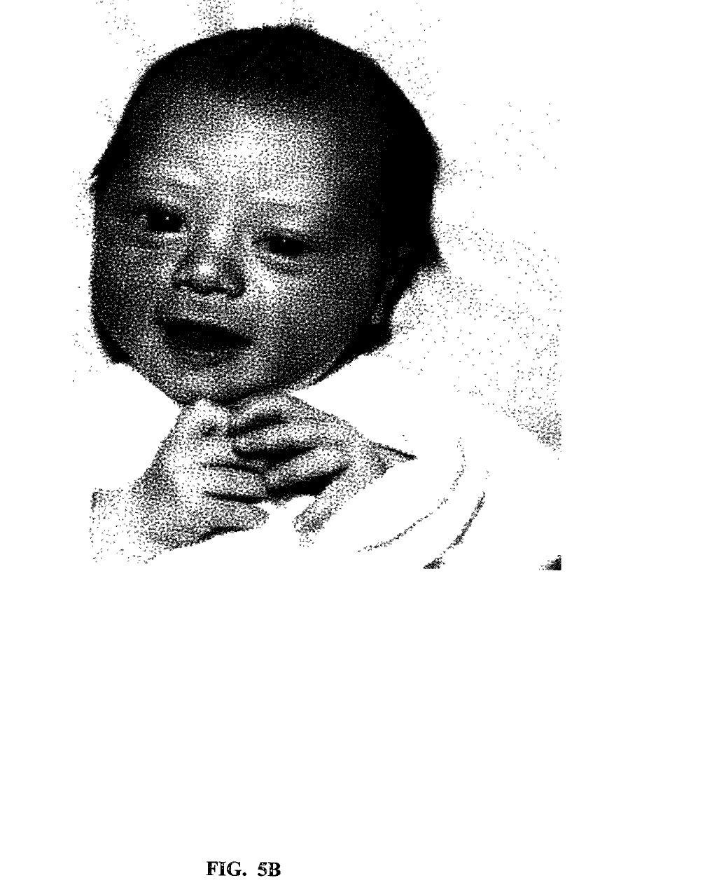

An elementary component summation processor 20 uses the reference and data carrier and angular orientation information to produce a pattern of associated sinusoids by calculating the contributions of the sinusoids to pixel intensities. In the example, the pixels intensities are represented as gray scale values, and the coded pattern is reproduced by a printer 22 as a black and white texture as depicted in FIG. 1. The texture can then be used in the same manner as a 2-D barcode. Alternatively, the coded pattern may be combined with a pre-existing image (FIG. 5A) in a scanner processor 24, to produce a combined image that includes the data as an added texture or graininess, as depicted in FIG. 5B.

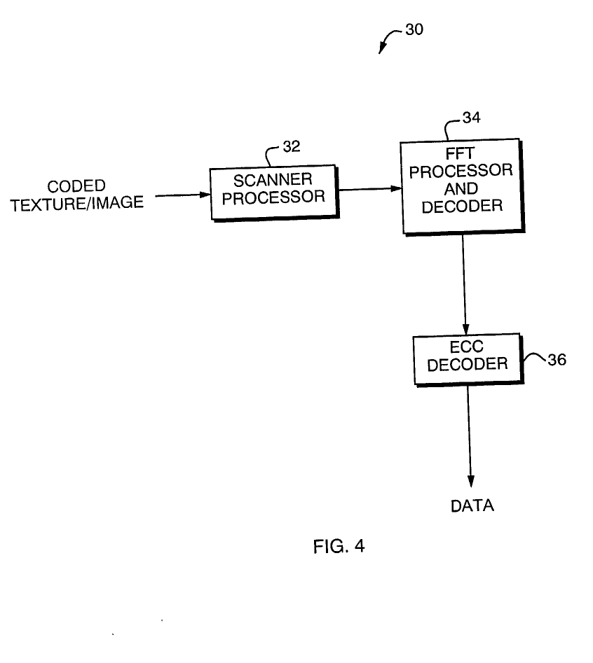

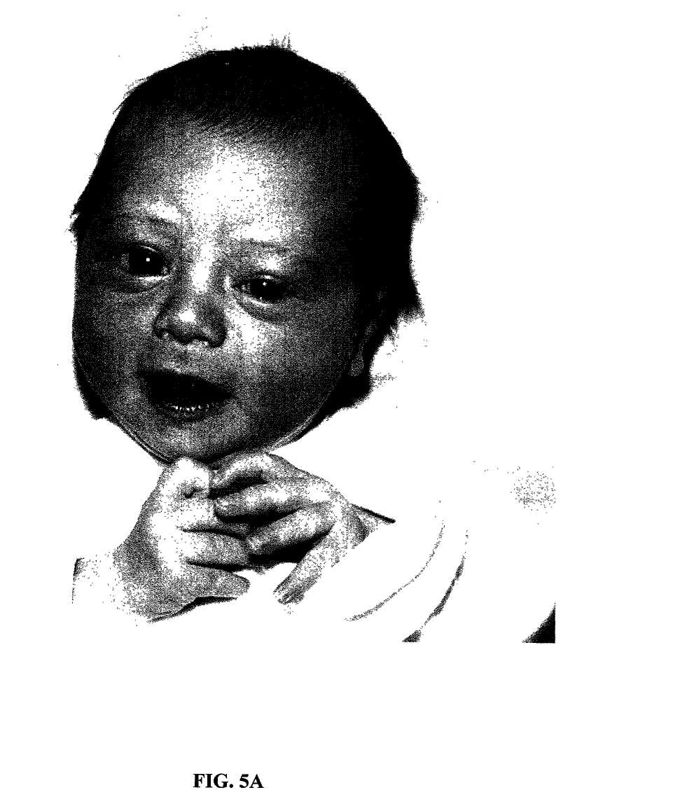

Referring now to FIG. 4, a decoding system 30 includes a scanner processor 32 that scans the encoded image and reproduces the pixel values as gray scale values. An FFT processor and decoder 34 next performs a 2-D FFT in the magnitude domain using the pixel values. Before performing the FFT, the processor may smooth the gray scale values by applying a 2-D Hamming window, in order to reduce boundary condition effects from the results of the FFT.

The FFT processor 34 produces one or more pairs of data points for each sinusoid that is included in the pattern. The data points for a given sinusoid are located on a circle of radius Rᵢ, where Rᵢ corresponds to the associated spatial frequency. The decoder then determines the reference orientation by identifying the maximum points that lie on or sufficiently close to a circle of radius R₀, where R₀ is the spatial frequency of the reference carrier. In the example, R₀ is the highest spatial frequency in the group of frequencies used to encode the data.

The decoder further determines the angles between the reference orientation and the data points associated with the remaining carriers or, as appropriate, the angles relative to sector boundaries, which are defined relative to the reference orientation. The decoder then enters a look-up table 39 to reproduce the associated image symbols. Alternatively, the decoder manipulates the angular information to reproduce the image symbols and arranges the symbols in an appropriate order to reproduce the N-bit payload. The decoder provides the N-bit string to an error correction decoder 36, which decodes the string as data and ECC symbols and, as appropriate, detects and/or corrects errors therein. The decoder will likely have to interpolate the angular orientation values it derives from the FFT. The system thus associates the derived, or measured, values with the spatially closest valid frequency and angular orientation values, without crossing associated sector boundaries. As discussed, if valid data is not produced, the system linearly scales the reference and data carrier frequency values and again decodes the results, until valid data is retrieved.

The system designer selects the data carriers such that they sufficiently spaced to enable reliable and rapid decoding using the Fourier domain of interest. With images that have expected resolutions of at least 300 dpi over a viewing, or recovery, region of the 0.25 square inches, good selections are

W₀≈660 rad. .inch⁻¹=26,000 rad.m⁻¹

for the reference carrier and

Wₖ≈60(10-k) rad. .inch⁻¹=2363(10-k) rad.m⁻¹

for the respective k data carriers.

The Fourier plane is segmented into 2d sectors for a data carrier that conveys d data symbols. If the symbols include b-bits, a given symbol is encoded into one of 2^{b} angular segments of a sector, since there are 2^{b} possible b-bit symbols represented by a given sector. Based on the value of a given symbol, the i^{th} b-bit image symbol associated with the k^{th} data carrier has a symbol value of S_{k,i}, and the angular orientation associated with the image symbol is

$${Θ}_{k , i} = {Θ}_{0} + π [ \frac{1}{40} + \frac{i}{{d}_{k}} + ( \frac{1}{20} + \frac{1}{{d}_{k}} ) \frac{{S}_{k , i}}{{2}^{{b}_{k}}} ]$$

where θ₀ is the reference angular orientation, dₖ is the number of symbols per carrier k and bₖ is the number of bits per symbol associated with carrier k. In the example, the image symbols are treated as Gray code symbols and assigned numerical values accordingly, to ensure that relatively slight errors in angular measurement translate to symbol values that can be readily corrected to the recorded symbol value.

In the example, the angular orientations θ_{k,i} do not span the entire associated sectors. Using the formula above, a boundary of π/20 radians is taken out of each sector. Thus, image symbols encoded on to the same data carrier will be spaced at least π/20 radians apart, and the estimates of local maxima that represent the symbols in the magnitude Fourier domain should not interference with one another.

To produce the coded pattern, the system determines how the sinusoids that correspond to the assigned spatial frequencies and angular orientations modify pixel intensity values. With the system using linear sinusoidal patterns as the elementary components, the contribution of the sinusoids at a given pixel at location (x, y) is:

$$c ( x , y ) = cos ( {w}_{R} ( x cos {Θ}_{0} + y sin {Θ}_{0} ) + ϕ ) + {\sum }_{k = 1}^{n} {\sum }_{i = 1}^{d} cos ( x cos {Θ}_{k , i} + y sin {Θ}_{k , i} ) + {ϕ}_{k , i} )$$

where φ₀ and φ_{k,i} are assigned phases that ensure that the contributions of the respective symbols in each sector do not overlap in a manner that adversely affects decoding.

The coded pattern is a gray scale texture that is composed of fairly high spatial frequency components. If an image with which the coded pattern is to be combined contains strong frequency components in the coding band of interest, combining the image and the pattern may adversely affect decoding. Accordingly, before combining the coded pattern and the non-code image, the system preferably linearly filters the image using an empirically defined finite impulse response two-dimensional low pass filter, to essentially remove from the underlying image those spatial frequency components that are in use for encoding. To speed the computations involved in the filtering, the system may use a sliding two-dimensional correlation window or matrix M, selected such that

M=UU^{T}

where U is a vector of length L.

The sliding of the matrix over the image can be expressed as the cascade of two one dimensional filtering stages over the two dimensions of the image. The elements of U represent the impulse response of the one-dimensional filtering stages. The two-dimensional filtering can thus be performed as 2L multiplications, as opposed to the L² multiplications that may be required with other 2-D filtering schemes. The dimensions of the matrix M may be made relatively small, to minimize the visual impact of the filtering.

The system may adjust the intensities or associated gains of the pixels in the combined image to ensure that pixel values remain below the maximum pixel intensity values of a printing device. Further, the system may use adaptive gain control techniques to improve the visual appeal of the combined image by, for example, mixing less of the gray scale texture with the white or brightest portions of the underlying image. The texture then does not overwhelm these portions.

The system may imbed different data in different portions of an underlying image or identical sets of data in various portions of the image. The system thus applies various coded patterns to the different portions of the image, or produces “coded tiles” that together represent the overall coded pattern that is combined with the underlying image. To smooth the transitions between the coded tiles, the system overlaps fade-in/fade-out portions of the tiles, leaving the centers of the tiles intact for decoding.

For tiles that carry different data, the overall coded pattern can be formulated as a weighted average of the tile textures, with the weighting associated with a given tile decreasing with the distance from the tile center. The weights may, for example, vary exponentially with distance.

We have explained the encoding and decoding system using an example, in which an N-bit payload is parsed into image symbols and the image symbols are encoded in order by assigning them to data carriers based on the positions of the symbols in the N-bit payload. In the example, the system assigns the first d image symbols to the data carrier with the highest frequency, the next d image symbols to the data carrier with the next highest frequency and so forth. The system may instead assign the first d image symbols to the lowest frequency data carrier, or use another assignment scheme. For example, the system may assign the first image symbol to the highest or lowest frequency data carrier, the next image symbol to another of the data carriers and so forth. As discussed, the system may also assign more image symbols to the higher frequency data carriers and fewer to the lower frequency carriers. In addition, the system may parse the N-bit payload into image symbols of different numbers of bits and assign the larger symbols to the higher frequency data carriers.

We have depicted that system as including a plurality of processors, such as the ECC encoder and the angle symbology encoder. The processors may be combined into a single processor or arranged as various other grouping of processors. The instructions for the operations that the processors perform may be stored on memory resident on the respective processors, or on memory that is resident on certain of the processors and shared with or made available to other processors. Alternatively, the instructions for one or more of the operations may be made available to or communicated to the processors by, for example, the controller. Further, the system may store, or transmit, print or otherwise provide the coded pattern and/or a combined image to a user. Similarly, a coded pattern or a combined image that contains the coded pattern may be transmitted to or provided in hardcopy to be scanned into the system for decoding.

The system is readily implemented by means of one or more digital processors, either general purpose or special purpose. Conventional signal processing software and algorithms are readily applied to perform the requisite processing described herein.

What is claimed is:

1. Method for use in encoding one or more symbols of data in at least one portion of an image, the at least one portion including a plurality of image elements, the method comprising:
determining a reference modulation pattern to be applied to a characteristic of the elements, the reference modulation pattern having a reference angular orientation and a reference frequency;
determining for each given symbol a data modulation pattern, the data modulation pattern having a frequency and an angular orientation relative to the reference angular orientation that corresponds to the given data symbol;
modifying the characteristic of the image elements in accordance with a coded pattern that is a combination of the reference and data modulation patterns.

2. Method for use in decoding at least one or more symbols of data encoded in at least one portion of an image, the at least one portion including a plurality of image elements, the method comprising:
determining in a coded pattern in the elements a reference modulation pattern that is associated with a reference angular orientation and a reference frequency;
determining in the coded pattern one or more data modulation patterns having respective angular orientations relative to the reference angular orientation and respective frequencies;
associating respective symbol values with the angular orientations associated with the data modulation patterns, and
arranging the symbols in accordance with the respective frequencies of the data modulation patterns to reproduce the data.

3. An image in which is encoded one or more symbols, the image including:
at least one portion including a plurality of image elements, and
a characteristic of the elements which is modulated to include a coded modulation pattern, the coded modulation pattern including contributions of
i. a reference elemental component, having a reference angular orientation and a reference frequency and
ii. one or more data elemental components having respective frequencies and angular orientations that correspond to the one or more symbols.

4. Method according to claim 1, wherein the characteristic is intensity values of the elements.

5. Method according to claim 2, wherein the characteristic is intensity values of the elements.

6. Image according to claim 3, wherein the characteristic is intensity values of the elements.

7. Method according to claim 1, wherein at least one of the modulation patterns is a sinusoidal linear pattern.

8. Method according to claim 2, wherein at least one of the components is a sinusoidal linear pattern.

9. Image according to claim 3, wherein at least one of the modulation patterns is a sinusoidal linear pattern.

10. Method according to claim 1, wherein the one or more symbols comprise a string of bits, and the method further comprises
parsing the string of bits into image symbols, and
for each image symbol determining a data modulation pattern having a frequency and an angular orientation relative to the reference angular orientation that correspond to the image symbol.

11. Method according to claim 2, wherein the one or more symbols comprise a string of bits, and the method further comprises
parsing the string of bits into image symbols, and
for each image symbol determining a data modulation pattern having a frequency and an angular orientation relative to the reference angular orientation that correspond to the image symbol.

12. Image according to claim 3, wherein the one or more data symbols comprise a string of bits that are parsed into image symbols, and the characteristic is modulated so as to produce in the elements respective data elemental components that correspond to the respective image symbols, with each data elemental component having a respective frequency and an angular orientation relative to the reference angular orientation that correspond to the respective image symbol.

13. Method according to claim 10 further including the step of assigning different spatial frequencies to the reference and data modulation patterns.

14. Method according to claim 12 wherein the reference modulation pattern is assigned a higher spatial frequency than the data modulation patterns.

15. Method according to claim 13 wherein a given spatial frequency is assigned to more than one data modulation pattern and respective patterns are associated with different relative angular orientations.

16. Method according to claim 11, wherein the reference modulation pattern has a higher spatial frequency than the data modulation patterns.

17. Method according to claim 1, wherein the at least one portion includes a plurality of respective portions of the image, the one or more data symbols include a plurality of respective sets of symbols, and a different respective set of symbols is encoded in each of the respective portions of the image.

18. Method according to claim 1, wherein the at least one portion includes a plurality of respective portions of the image, the one or more data symbols include a plurality of symbols and an identical set of symbols is encoded in each of the respective portions of the image.

19. Method according to claim 1, wherein the one or more data symbols include a plurality of symbols that represent a data message and error correction redundancy information.

20. Method according to claim 1, further comprising applying a linear filtering to the at least one portion.

21. Apparatus for use in encoding one or more data symbols in at least one portion of an image, the at least one portion including a plurality of image elements, the apparatus including:
an angular symbology encoder that associates the one or more data symbols with respective second modulation patterns that are associated with angular orientations relative to a reference first modulation pattern in the elements, the angular orientations being selected so as to have values that correspond to the respective one or more data symbols; and
a processor that encodes the plurality of elements by combining the first and second modulation patterns to determine a coded pattern that represents changes to a characteristic of the plurality of the elements to encode the one or more data symbols in the plurality of the elements.

22. Apparatus for use in decoding one or more data symbol encoded in at least one portion of an image, the at least one portion including a plurality of image elements, the apparatus comprising:
a mechanism that determines values of angular orientations of data modulation patterns in the elements relative to a reference modulation pattern in the elements, the patterns being produced by applying modulations to a characteristic of the elements, the values corresponding respectively to the one or more data symbols; and
a decoder for assigning the one or more data symbols to the respective angular orientations and arranging the symbols in order according to the frequencies associated with the data modulation patterns.

23. Apparatus according to claim 21, wherein the characteristic comprises intensity values of the elements.

24. Apparatus according to claim 22, wherein the characteristic comprises intensity values of the elements.

25. Apparatus according to claim 21, wherein at least one of the patterns comprises a sinusoidal modulation pattern of the characteristic.

26. Apparatus according to claim 22, wherein at least one of the patterns comprises a sinusoidal modulation pattern of the characteristic.

27. Apparatus according to claim 21, wherein the one or more data symbols comprise a plurality of data symbols, and the angular symbology processor determines respective modulations to be applied to the characteristic to produce in the elements respective data modulation patterns corresponding to respective data symbols, each of the respective data modulation patterns having a respective angular orientation relative to a reference modulation pattern, the angular orientations for the data modulation patterns being selected so as to have respective values that correspond to the respective data symbols.

28. Apparatus according to claim 27, wherein the reference modulation pattern has a higher spatial frequency than any of the data modulation patterns.

29. Apparatus according to claim 27, wherein at least certain of the data modulation patterns have identical spatial frequencies.

30. Apparatus according to claim 21, wherein the at least one portion includes a plurality of respective portions of the image, the one or more data symbols includes a plurality of respective sets of data symbols, and a different respective set of data symbols is encoded in each of the respective portions of the image.

31. Apparatus according to claim 21, wherein the at least one portion includes a plurality of respective portions of the image, and an identical set of data symbols is encoded in each of the respective portions of the image.

32. Apparatus according to claim 21, wherein the one or more symbols represent a data message and error correction information.

33. Apparatus according to claim 21, further comprising a filter that applies a linear filtering to the at least one portion.

34. Apparatus according to claim 21, wherein certain of the data modulation patterns have identical spatial frequencies.

35. Apparatus according to claim 22, wherein the at least one portion includes a plurality of respective portions of the image, the one or more data symbols include a plurality of respective sets of data symbols, and a different respective set of data symbols is encoded in each of the respective portions of the image.

36. Apparatus according to claim 22, wherein the at least one portion includes a plurality of respective portions of the image, and an identical set of data symbols is encoded in each of the respective portions of the image.

37. Apparatus according to claim 22, wherein the one or more symbols includes symbols that represent a data message and error correction information.

38. Method according to claim 11, wherein at least certain of the patterns have identical spatial frequencies.

39. Method according to claim 2, wherein the at least one portion includes a plurality of respective portions of the image, the one or more data symbols include a plurality of respective sets of data symbols, and a different respective set of data symbols is encoded in each of the respective portions of the image.

40. Method according to claim 2, wherein the at least one portion includes a plurality of respective portions of the image, and an identical set of data symbols is encoded in each of the respective portions of the image.

41. Method according to claim 2, wherein the one or more data symbols represent a data message and error correction information.

42. Computer-readable memory comprising computer-executable program instructions for use in encoding one or more data symbols in at least one portion of an image, the at least one portion including a plurality of image elements, the instructions, when executed, causing:
determining a reference modulation pattern to be applied to a characteristic of the elements, the reference modulation pattern having a reference angular orientation and a reference frequency;
determining for each given symbol a data modulation pattern, the data modulation pattern having a frequency and an angular orientation relative to the reference angular orientation that corresponds to the given data symbol;
modifying the characteristic of the image elements in accordance with a coded pattern that is a combination of the reference and data modulation patterns.

43. Computer-readable memory comprising computer-executable program instructions for use in decoding one or more data symbols encoded in at least one portion of an image, the at least one portion including a plurality of image elements, the instructions, when executed, causing:
determining in a coded pattern in the elements a reference modulation pattern that is associated with a reference angular orientation and a reference frequency;
determining in the coded pattern one or more data modulation patterns having respective angular orientations relative to the reference angular orientation and respective frequencies;
associating respective symbol values with the angular orientations associated with the data modulation patterns, and
arranging the symbols in accordance with the respective frequencies of the data modulation patterns to reproduce the data.

44. Memory according to claim 42, wherein the characteristic comprises intensity values of the elements.

45. Memory according to claim 43, wherein the characteristic comprises intensity values of the elements.

46. Memory according to claim 42, wherein at least one of the patterns comprises a sinusoidal modulation pattern of the characteristic.

47. Memory according to claim 43, wherein at least one of the patterns comprises a sinusoidal modulation pattern of the characteristic.

48. Memory according to claim 42, wherein the reference pattern has a higher spatial frequency than the data patterns.

49. Memory according to claim 42, wherein at least certain of the patterns have identical spatial frequencies.

50. Memory according to claim 42, wherein the at least one portion includes a plurality of respective portions of the image, the one or more data symbols includes a plurality of respective sets of data symbols, and a different respective set of data symbols is encoded in each of the respective portions of the image.

51. Memory according to claim 43, wherein the at least one portion includes a plurality of respective portions of the image, the one or more data symbols includes a plurality of respective sets of data symbols, and a different respective set of data symbols is encoded in each of the respective portions of the image.

52. Memory according to claim 42, wherein the at least one portion includes a plurality of respective portions of the image, and an identical set of data symbols is encoded in each of the respective portions of the image.

53. Memory according to claim 43, wherein the at least one portion includes a plurality of respective portions of the image, and an identical set of data symbols is encoded in each of the respective portions of the image.

54. Memory according to claim 42, wherein the one or more data symbols represent a data message and error correction information.

55. Memory according to claim 43, wherein the one or more data symbols represent a data message and error correction information.

56. Memory according to claim 42, wherein the instructions, when executed, also cause a linear filtering to be applied to the at least one portion.
